(19) United States
(12) Patent Application Publication
(10) Pub. No.: US 2015/0337429 A1
(43) Pub. Date: Nov. 26, 2015

(54) TREATMENT TO ENHANCE STRUCTURAL COMPONENTS

(71) Applicant: Trevor Lavern Wirtjes, Melrose, MN (US)

(72) Inventor: Trevor Lavern Wirtjes, Melrose, MN (US)

(21) Appl. No.: 14/283,284

(22) Filed: May 21, 2014

(51) Int. Cl. C23C 8/32; C23C 8/10; F16L 57/06; C23F 17/00

(52) U.S. Cl. CPC C23C 8/32; C23F 17/00; C23C 8/10; F16L 57/06

(57) ABSTRACT

A process enhances at least surface hardness or chemical resistance of a metal-plated iron-containing component. The process is performed by:
a) providing a plated iron-containing (particularly steel or carbon-iron containing) component;
b) stripping metal plating from at least some surfaces of the plated iron-containing component, exposing iron-containing material within a body of the component;
c) nitrocarburizing exposed iron-containing material of the body to at least enhance surface hardness of the exposed iron-containing material of the body.

### BACKGROUND OF THE INVENTION

1. Field of the Invention

The present technology relates to the improvement of properties is components and parts, particularly in the hardening of metal plated steel components and parts, and more particularly for methods for the improvement of properties such as hardness in specialty components or parts originally provided as a metal plated element.

2. Background of the Art

Apparatus and structure are generally manufactured with individual components that are specifically designed and shaped for specific or even unique purposes. For decorative purposes, many of these parts and components are provided with plating, primarily as a decorative function, although providing some potential environmental protection.

Plating is a surface covering in which a metal is deposited on a conductive surface. Plating has been done for hundreds of years; it is also critical for modern technology. Plating is used to decorate objects, for corrosion inhibition, to improve solderability, to harden, to improve wearability, to reduce friction, to improve paint adhesion, to alter conductivity, to improve IR reflectivity, for radiation shielding, and for other purposes Thin-film deposition has plated objects as small as an atom, therefore plating finds uses in nanotechnology.

There are several plating methods, and many variations. In one method, a solid surface is covered with a metal sheet, and then heat and pressure are applied to fuse them (a version of this is Sheffield plate). Other plating techniques include vapor deposition under vacuum and sputter deposition. Recently, plating often refers to using liquids. Metalizing refers to coating metal on non-metallic objects.

In electroplating, an ionic metal is supplied with electrons to form a non-ionic coating on a substrate. A common system involves a chemical solution with the ionic form of the metal, an anode (positively charged) which may consist of the metal being plated (a soluble anode) or an insoluble anode (usually carbon, platinum, titanium, lead, or steel), and finally, a cathode (negatively charged) where electrons are supplied to produce a film of non-ionic metal. Electroless plating, also known as chemical or auto-catalytic plating, is a non-galvanic plating method that involves several simultaneous reactions in an aqueous solution, which occur without the use of external electrical power. The reaction is accomplished when hydrogen is released by a reducing agent, normally sodium hypophosphite (Note: the hydrogen leaves as a hydride ion), and oxidized, thus producing a negative charge on the surface of the part. The most common electroless plating method is electroless nickel plating, although silver, gold and copper layers can also be applied in this manner. Metals used in plating include, but are not limited to chromium, zinc, tin, rhodium, platinum, metal alloys, silver and gold.

Many component parts in mechanical and electromechanical systems are provided as stock components with plating on them. The components (e.g., screws, bolts, nuts, washers, threaded attaching elements, snaps, clips, supports, cylinders, pipes, doors, flaps, etc.) are designed for general environmental uses, but are not necessarily designed for extreme conditions of heat, pH, abrasion, chemical exposure, impact and abrasion. It would be quite expensive to have such fitted parts custom-made to improve their performance in such extreme conditions.

Numerous processes are known for the surface treatment of metal surfaces to improve surface properties. In addition to coating or laminating additional layers onto surfaces, physical processes such as abrading and grinding are used, as well chemical modification treatments such as anodizing, etching, infusion, atomic embedding, nitriding, carburizing and nitrocarburizing are known. Various nitrocarburizing treatments are known in the art for metal surface enhancement.

U.S. Pat. No. 8,414,710 (Minemura) enables a method for a surface treatment of a metal material, which comprises subjecting a metal material such as an Fe alloy, a Ni alloy and an Al alloy to a heat treatment in the presence of an amino-based resin such as a melamine-formaldehyde resin. The amino-based resin can be caused to be present with the metal material by a method wherein the resin is applied on the surface of the metal material, directly or via a solvent such as water, or wherein the amino-based resin is placed in a container, and the container and the metal material are placed in a heat treatment furnace. The above heat treatment allows a passivated film to disappear from the metal material. Further, a subsequent elevation of temperature and the supply a nitriding gas allows the performance of a nitriding treatment being several times more effective than a conventional treatment, and a subsequent supply of a carburizing agent allows the performance of a carburizing treatment. A passive film composed of iron oxide, which is spontaneously generated by being oxidized by oxygen contained in the air, is present on the surface of the iron group alloy including stainless steel. For example, the passive film inhibits the progress of the nitriding process when the stainless steel is subjected to the nitriding treatment. As a result, the nitriding efficiency tends to be lowered.

U.S. Pat. No. 8,287,667 (Holly) discloses a ferritic nitrocarburized surface treatment of cast iron brake rotors providing oxidation resistance, good braking performance and absence of distortion. Machined brake rotors are pre-heated, then immersed into a high temperature molten nitrocarburizing salt bath for a first predetermined dwell time. After removing the brake rotors from the nitrocarburizing salt bath, the brake rotors are directly immersed into an oxidizing salt bath at a lower temperature than the nitrocarburizing salt bath so that the brake rotors are thermally quenched. After a predetermined second dwell time in the oxidizing salt bath, the brake rotors are removed therefrom and further cooled to room temperature, either by water application thermal quenching or slow cooling in air. A fixture provides stable holding the brake rotors with a minimum of contact during placement in the salt baths.

According to U.S. Pat. No. 8,083,866 (Baudis), one great disadvantage of most of the commonly used stainless steel types is that relatively soft steels have surfaces that can be scratched by hard particles such as dust, sand and the like. Most types of stainless steel, apart from the so-called martensitic stain steels, cannot be hardened with the aid of physical processes such as annealing and chilling. The low surface hardness frequently stands in the way of a use of the stainless steel. A further disadvantage of most types of stainless steel is the strong tendency to corrosion seizing, meaning the fusing of two surfaces that slide against each other as a result of adhesion.

To counter this problem, it is known to subject work pieces made from stainless steel to a thermo-chemical treatment. During this treatment, the stainless steel surface is enriched with nitrogen through the process of nitrating or nitro-carbureting in a gas atmosphere (ammonia atmosphere), in plasma (nitrogen/argon atmosphere) or in the molten salt bath (using molten cyanates), wherein iron nitrides and chromium nitrides form. The resulting layers are formed from the material itself, meaning they are not deposited from the outside, in contrast to galvanic or physical layers, and therefore have extremely high adhesive strength. Depending on the length of treatment, hard layers form, which have a thickness ranging from 5 to 50 μm. The hardness of such nitrated or nitro-carbureted layers on stainless steel reaches values exceeding 1000 units on the Vickers Hardness Scale because of the high hardness of the resulting iron nitrides and chromium nitrides.

The problem with a practical use of such nitrated or nitro-carbureted layers on stainless steel is that these layers are hard, but also lose their corrosion resistance as a result of the relatively high treatment temperature, which is in the range of 580° C. during the nitrating or the nitro-carbureting process. At this temperature, the diffused-in elements nitrogen and carbon form stable chromium nitrides (CrN) and/or chromium carbides (Cr₇C₃) with the chromium in the surface region of the component. In this way, the free chromium that is absolutely necessary for the corrosion resistance is removed from the stainless steel matrix up to a depth of approximately 50 μm below the surface and is converted to chromium nitride or chromium carbide. The component surface becomes hard because of the forming of iron nitride or chromium nitride, but is also subject to corrosion. During the use of the work piece, these types of layers become quickly worn down and/or are eroded because of corrosion.

U.S. Pat. No. 7,972,449 (Abd Elhamid) describes a metal composite for use in electrochemical devices is disclosed. The metal composite comprises a stainless steel interior component and a deposited nitrided metal exterior layer, wherein the nitrided exterior layer has lower electric contact resistance and greater corrosion resistance than the stainless steel interior component. A bipolar plate made of such metal composite and methods of producing the metal composite and bipolar plate are also disclosed using a metal deposition process.

U.S. Pat. No. 7,896,981 (Weber) describes a process for providing a nitrided SUS 316L stainless steel component suitable for use in the assembly of a portable consumer electronic product, comprising: heating a nitrogen based salt bath to an average temperature of no more than 580.degree. C.; forming an initial nitride layer by, continuously exposing at least a portion of the SUS 316L stainless steel component to the salt bath; removing the nitrided SUS 316L stainless steel component from the salt bath after no more than 90 minutes has elapsed; and forming a finished nitride layer by performing at least one finishing operation on the initial nitride layer. Finishing operations such as buffing and polishing are used.

U.S. Pat. No. 7,708,465 (Yamamoto) describes highly reliable hydrodynamic bearing device and spindle motor are provided as a result of improving cleanliness by using an iron metal having austenite structure, which is a non-magnetic body, and solving the problem of lowering of abrasion resistance due to low hardness. A shaft is formed using an iron metal having austenite structure, and a surface treated layer dispersed with solid lubricant is formed on at least a part of the surface of a shaft facing a sleeve by spraying fine particles of solid lubricant. Cleanliness is improved since the shaft is formed using an iron metal having austenite structure, which is a non-magnetic body. Further, since the surface treated layer dispersed with solid lubricant is arranged on the bearing surface, the abrasion resistance is enhanced and excellent bearing reliability is obtained.

U.S. Pat. No. 7,204,952 (Poor) describes vacuum carburizing of ferrous workpieces performed at low pressure in a vacuum furnace using a carburizing hydrocarbon as the carburizing medium. The furnace is constructed to be generally transparent to the carburizing hydrocarbon so that cracking tends to occur at the workpiece which functions as a catalyst to minimize carbon deposits. The carburizing hydrocarbon is supplied in liquid form to an injector which injects the liquid carburizing hydrocarbon as a vapor to produce a uniform dispersion of the carburizing hydrocarbon about the workpiece, resulting in uniform carburizing of the workpieces. A vacuum furnace for carburizing ferrous workpieces therein comprising: a furnace casing defining a furnace chamber therein closed at one end by a vacuum sealable door; a heater within the furnace chamber; a vacuum pump in fluid communication with the furnace chamber; an injector of the pulse operating type vacuum sealed to an opening in the casing, the injector having an inlet in fluid communication with a source of liquid carburizing hydrocarbon under pressure in relation to the vacuum furnace and an outlet in fluid communication with the furnace chamber; a device for adding a source of monatomic nitrogen into the furnace chamber; and, a controller for controlling i) the heater for regulating the temperature of the workpiece in the furnace chamber, ii) the vacuum pump for regulating the pressure of the furnace chamber, and iii) the injector for regulating the pulsing of the liquid carburizing hydrocarbon.

U.S. Pat. No. 6,656,293 (Black) describes a method for treating a surface of a first component wherein at least a portion of the surface of the first component contacts a surface of a second component. The method includes forming a compound layer at at least a portion of the surface of the first component by a thermochemical diffusion treatment (including nitrocarburizing) and isotropically finishing the at least a portion of the surface of the first component that contacts the surface of the second component.

U.S. Pat. No. 6,330,748 (Muntnich) describes a method of making a formed body from iron alloys, in particular a cage for use in a radial roller bearing, axial roller bearing or linear roller bearing, includes the steps of treating a metal strip by heat treatment or thermochemical treatment for providing the metal strip with desired properties with respect to hardness, strength and wear resistance, and punching a plurality of spaced slots into the metal strip for formation of pockets for receiving rolling elements.

U.S. Pat. No. 5,810,947 (Wu) shows that the adhesive strength and hardness of chromium nitride(CrN) film deposited on SKD 61 tool steel was significantly enhanced by a nitriding process on the surface the tool steel before coating with a CrN film. These nitriding processes included nitrocarburing, gas nitriding, and plasma nitriding, respectively. After nitriding, the surface of tool steel was repolishing with grits #600, #1000, #1800 of SiC grinding paper, as well as #1000 grinding paper and diamond paste, respectively. After repolishing, the CrN film was deposited by the cathodic arc ion plating deposition process at low temperature of 200° C. The present invention was related to the process modification for enhancing the adhesive strength and surface hardness of CrN film deposited on tool steels. This method included a nitriding process and a repolishing followed by the cathodic arc ion plating deposition. The process for modifying the surface of tool steel includes: polishing with grinding paper a surface of tool steel, cleaning said polished tool steel surface with acetone, then washing said tool steel surface with deionized water in an ultrasonic cleaner, nitriding said polished tool steel surface using a step which is a member of the group consisting of:

a) nitrocarburizing said tool steel surface in a furnace at a temperature of 500.degree.-580° C., wherein said furnace is filled with a gas containing equal parts of ammonia gas and RX gas, said RX gas is produced by heating air and propane at 950° C.,

b) gas nitriding said tool steel surface in a thermal furnace filled with pure ammonia gas at a temperature of 460° C.-560° C., and

c) plasma nitriding said tool steel surface in a plasma nitriding furnace filled with a gas mixture containing 25% nitrogen gas and 75% hydrogen gas at a temperature of 460.degree.-560° C.,

then repolishing with #600, #1000, or #1800 grinding paper said nitrided tool steel surface, cleaning said repolished tool steel surface with acetone, then washing said repolished tool steel surface with deionized water in an ultrasonic cleaner, depositing a layer of CrN on said nitrided surface of said tool steel under a nitrogen gas pressure of 25 millitorr, at a voltage of −100 volts, a temperature of 200° C., and at a deposition rate of 2 nm/sec for 30 minutes, to form a hard layer containing 6.0-8.7% by weight nitrogen and 0-3.2% by weight carbon. This is clearly a complex and prolonged process.

All references cited herein are incorporated by reference in their entirety. There is still a need for improved product and processing for metal parts and components.

### SUMMARY OF THE INVENTION

A process enhances at least surface hardness of a metal-plated iron-containing component. The process is performed by:
a) providing a plated iron-containing (particularly steel or carbon-iron containing) component;
b) stripping metal plating from at least some surfaces of the plated iron-containing component, exposing iron-containing material within a body of the component;
c) nitrocarburizing exposed iron-containing material of the body to at least enhance surface hardness of the exposed iron-containing material of the body.

### BRIEF DESCRIPTION OF THE FIGURES

FIG. 1 is Table 1. Characteristics of thermochemical processes involving nitrogen and/or carbon

FIG. 2 is Table 2. An example of energy requirements for two process routes, one being nitrocarburizing.

FIG. 3A is a cross-section of a metal-plated steel bolt.

FIG. 3B is a cross-section of a stripped metal-plated steel bolt.

FIG. 3C is a cross-section of a nitrocarburized, stripped, metal-plated steel bolt.

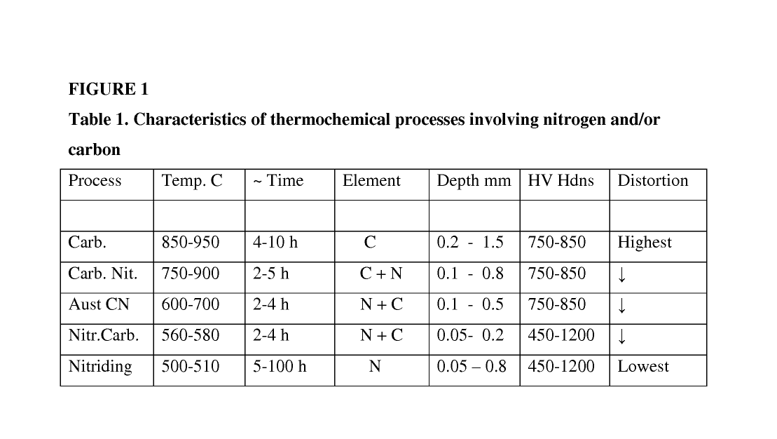

### DETAILED DESCRIPTION OF THE INVENTION

A process enhances at least surface hardness of a metal-plated iron-containing component. The process is performed by:
a) providing a plated iron-containing (particularly steel or carbon-iron containing) component;
b) stripping metal plating from at least some surfaces of the plated iron-containing component, exposing iron-containing material within a body of the component;
c) nitrocarburizing exposed iron-containing material of the body to at least enhance surface hardness of the exposed iron-containing material of the body.
d) The process of claim 1 wherein the iron-containing component is a steel component.

The metal plating may be a plating of any metal and particularly any metal selected from the group consisting of chromium, zinc, tin, rhodium, platinum, metal alloys, silver and gold. Preferably the metal plating is a plating of metal selected from the group consisting of chromium, zinc, tin, rhodium, platinum, and metal alloys.

The process is preferably performed where the metal plating is stripped from the at least some (and preferably all or substantially all) surfaces by an acid treatment process. It is a further advantage for mild oxidation to be performed on the nitrocarburized surface.

There are significant controls that may be exercised in the performance of the processes of the present technology and in the final structures produced by these processes. Where significant tolerances are required in the final product, the final product may be produced with nearly identical dimensions to those of the originally manufactured plated product. The thickness of the plating as well as the dimensions of the original article are known. As the preferred chemical stripping (removal) of the plating produces an intermediate article of the iron-containing (preferably steel-containing) sub-structure of dimensions that can be measured or fairly specifically estimated (e.g., within tolerance levels for the final product), the nitrocarburizing can be performed in a manner that will cause surface growth or expansion from the surfaces of the intermediate article to a final thickness that will return the overall dimensions of the nitrocarburized product to a desired level of total thickness and dimensions that will be within the tolerance levels for the original plated article. Those skilled in the art are familiar with the rate and control of surface growth on metal and especially steel surfaces during nitrocarburizing. By employing that skill and my in-process observation (e.g., laser reflection and sensing to measure thickness changes or dimensions), the process can be stopped when the desired dimension(s) or dimensions within the level of tolerances for the product have been reached. This may be done by manual controls or processor-directed automatic controls on the nitrocarburizing systems and furnaces.

The degree of correspondence in dimensions between the final, stripped, nitrocarburized product and the original plated part or component is chosen within the needs and design requirements of the original part or component and the desired degree of enhanced surface properties that are desired in the final product. For purposes of description, without necessarily limiting the scope of claimed subject matter, the following descriptions are provided.

A nominal dimension (length, width or height for example) of 100 units is assumed. Where the tolerance of the article is required to be ±0.01% (e.g., ±0.01 units), the dimensions of the final stripped and nitrocarburized article should also be within that identical tolerance range.

Therefore if the original article had a nominal dimension of 100.00 units and a plating layer thickness of 0.05 units, after stripping (reasonably assuming a precise result because of the controlled chemical environment) the intermediate article product would have nominal dimensions of 99.95 units. The nitrocarburizing process would then be performed until the nominal dimension of the article, part or component is within the design tolerances of the original plated article, part or component. This means that the final nominal dimension of the nitrocarburized article, part or component would be 100.00±0.01 units, of 99.99-100.01 units, with 0.049 to 0.051 units of total single dimension growth being provided in the nitrocarburizing process.

The processes described herein therefor are capable of providing parts, components and articles with physical dimensions within high levels of parameters and maximum tolerances allowed in the articles, parts or components. The processes for enabling the results in articles are well within the skill of the ordinary artisan. Thus the processes can produce articles within small percentages of tolerances as well as within the strictest levels of tolerance, whether those tolerances are in single digit percentages (e.g., ±8%, 5%, 4%, 2%, ±1.5%, or about ±1%) or where the tolerances are in small portions of percentages allowed for maximum deviations (Standard deviations, number average deviations, area weighted deviations or absolute deviation) such as ±0.9% deviation, ±0.6%, ±0.5, ±0.3%, ±0.15%, ±0.1, ±0.08%, ±0.05, ±0.03%, ±0.02%, 0.01% and less, down to even ±0.001% deviations.

The present technology enables high quality, extreme condition-resistant components that are available for use in designed systems to be strengthened for purposes of resistance to abrasion, chemical environments, stress and the like, while retaining close accommodation to the tolerances of the system.

These benefits can be provided by a process in which an iron-containing plated part or component, especially a plated carbon-steel part or components is enhanced by first stripping plating off at least some surfaces on the part or component and then nitrocarburizing the stripped surfaces. The part or component may be further enhanced by a post-nitrocarbonizing mild oxidation treatment.

An important feature of nitriding and nitrocarburizing is that they are “low temperature methods” whereas carburizing and carbonitriding are “high temperature methods”. Here low temperature refers to a temperature below that where phase transformation to austenite starts (A1), and high temperature is above said temperature. A valuable consequence is notably reduced distortion of treated parts. This can often save time and costs by eliminating the need for post grinding to meet dimensional tolerance requirements. The production cycle of a part therefore becomes faster and cheaper. A limitation caused by the lower temperature is that the diffusion rate for nitrogen and carbon is modest, which sets limits on the case depths that can be obtained. Carburizing and carbonitriding give a surface hardness in the range of 750-850 HV that is largely independent of the steel type, whereas nitriding and nitrocarburizing give a wide possible range of surface hardness determined by the steel selection. Austenitic nitrocarburizing is a process that has characteristics in between the high temperature methods of carburizing and carbonitriding and the low temperature processes of nitrocarburizing and nitriding.

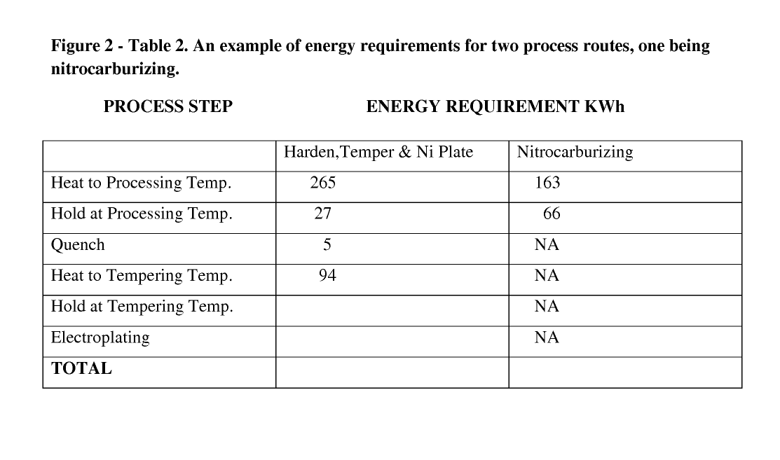

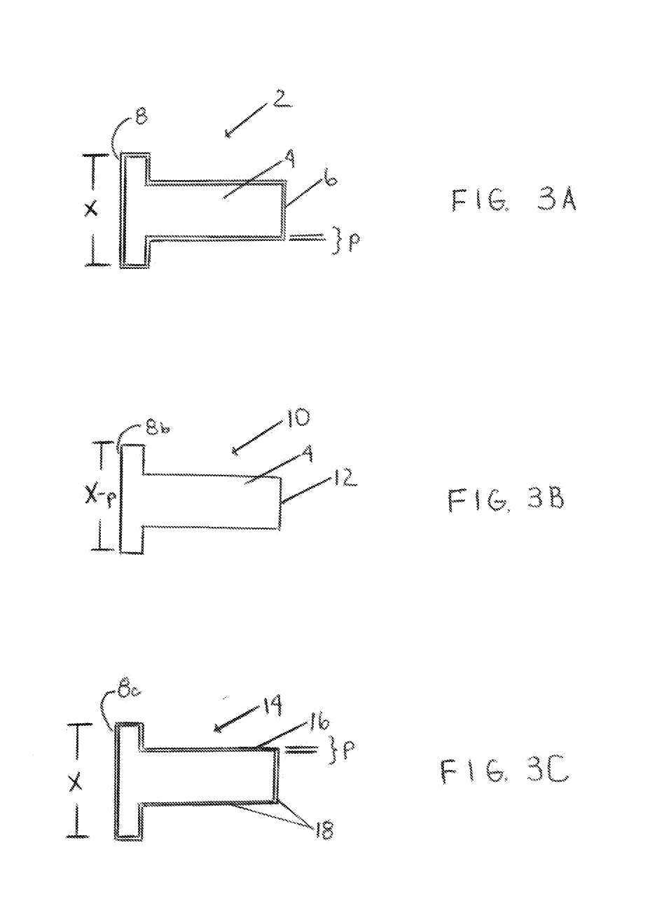

A consequence of the low process temperature, the short process time and the elimination of productions steps is low energy consumption. Table 2 (FIG. 2) shows an example in which the energy saving was about 50% when the process route was changed to nitrocarburizing. The process medium can be salt, gas or plasma. The salt bath processes are losing market to atmospheric gas pressure processes due to the environmental problems with salts, which contain cyanide. The use of plasma processes has steadily increased in recent decades although the number of installations is still limited in comparison with atmospheric pressure processes. Note FIG. 3 (Table 3) which shows Nitriding and nitrocarburizing features and process names. features and process names.

A nitriding/nitrocarburizing cycle has three major steps: 1) heating to temperature, 2) holding at temperature for a sufficient time to reach the required nitriding depth, and 3) cooling. There are optional additional steps of preheating/pre-oxidation and post-oxidation used in nitrocarburizing.

There may also be pollution from manufacturing machinery in the form of hydraulic fluids, tool wear debris, chips, turnings, blasting agents and abrasives, and, if machines are used for different metals such as aluminum, even residues from non-ferrous metals. Anti-corrosives used to protect parts from rust in storage and transport may be a further source. Contaminations may be in the form of surface films or layers, or particles.

An increased amount of additive reduced hardness and gave uneven and locally zero compound layer thickness. The specific chemicals sulfur and phosphorous added to the cutting oil as well as sodium, boron, and calcium in cutting fluids all had a negative impact on compound layer formation. There is also a negative influence if fluids were allowed to dry on the surface before nitriding or nitrocarburizing.

For parts subjected to high stress, the normal state of the steel prior to nitriding or nitrocarburizing may be hardened and tempered at a tempering temperature at least 20-30° C. higher than the nitriding/nitrocarburizing temperature in order to prevent loss of hardness during nitriding/nitrocarburizing. If nitriding/nitrocarburizing is conducted primarily to increase resistance to wear and scuffing, steels in annealed or normalized conditions can be used. Cast irons may be nitrided or nitrocarburised in the annealed state. For parts that have been subject to turning, drilling or any other machining or cold forming operation, it is necessary to release internal stresses by stress-relieving annealing. After stress relieving the part dimensions are adjusted by fine machining or grinding to meet the tolerance requirements before nitriding/nitrocarburizing. The temperature for stress relieving should preferably be 20-30° C. above the nitriding/nitrocarburizing temperature in order to avoid stress relieving and concurrent distortion during nitriding/nitrocarburizing.

Cleaning is ordinarily an important process step before nitriding/nitrocarburizing as surface contaminants disturb nitride layer formation. In manufacturing steps before heat treatment, contamination sources are lubricants, coolants and cuttings oils used in machining and grinding.

In the present technology, the stripping, especially chemical stripping, and most particularly with acid chemical stripping of the plating, those stripping processes enable nitrocarburizing to be successfully performed without any specific cleaning process step after stripping, other than washing away (e.g., with moderate pH water, low ion or deionized water) of the acid components.

### Preheating and Pre-Oxidation

Preheating in air at a temperature in the range of 350-450° C. (662-842° F.) for 30-60 minutes is a standard procedure before nitrocarburizing for a number of reasons:
The process time in the nitrocarburizing furnace, which is more costly than the preheat furnace, is reduced.
Heating in air leads to surface oxidation that is found to accelerate compound layer nucleation and growth during nitrocarburizing.
Residues on the part surfaces are oxidized and vaporized, resulting in cleaner parts and improved nitriding ability.
Safety is ensured for salt bath nitriding/nitrocarburizing by removing any water that has adhered to the parts.

### Nitrocarburizing

In principle, the same type of furnaces can be used in nitrocarburizing as in gas nitriding; however, one special feature of nitrocarburizing is that the final cooling is usually fast. Brick-lined sealed quench furnaces with an oil quenching capability of the same type as for carburizing are therefore used. Other common solutions are box-type atmosphere furnaces, often with fibre lining, and batch furnaces with a vacuum pumping option for quick atmosphere conditioning and with integrated gas cooling (FIG. 8b), as well as metallic retort furnaces gives specific advantages and disadvantages of each type of furnace.

Specific features of each furnace type. Brick-lined furnaces tend to have slow ammonia level changes. Slow change in the atmosphere furnace dissociation in atmosphere.

Modular constructions with a metallic retort can exhibit a fast change with fast ammonia furnace atmosphere dissociation. They can also exhibit low nitriding potential although with a lifetime of retort without hydrogen addition. Evacuation of the entire furnace is possible.

Furnaces for gaseous nitrocarburizing may include known structures of: a) Sealed quench furnace with integrated oil quench bath. b) a one chamber vacuum/atmosphere furnace with integrated gas cooling also with the gas system.

In processing, after the parts have been stripped, they are loaded into baskets or fixtures and transferred to the furnace for heating (optionally preceded by preheating) to process temperature, 570-580° C. (1058-1076° F.), and kept at that temperature for a time that yields the desired compound layer and diffusion depth. As in the case of nitriding, close temperature uniformity, typically ±5° C. (9° F.), is required.

A low pressure nitriding process starts with the evacuation of the furnace chamber followed by refilling it with nitrogen to atmospheric pressure to enable fast heating by convection. When the process temperature is reached, vacuum pumping to a pressure of 150-400 mbar is performed. Ammonia and hydrogen are added as nitriding media. It may be necessary to use a higher relative amount of ammonia than for atmospheric pressure nitriding. The major benefits of the vacuum nitriding process are low consumption of gases, almost no effluents, a pure atmosphere, clean surfaces and fast change of nitriding parameters. The disadvantages are relatively high equipment costs and problems with uniformity in the nitriding result for parts with deep narrow bores. High pressure nitriding is a very different process. It is carried out in nitrogen, which at normal ambient pressure is neutral with respect to nitriding ability, but which at very high pressure up to 1000 bar has a nitriding effect. Its benefits are the use of environmentally friendly nitrogen gas and the possibility to treat steels that are difficult to nitride. The major disadvantage is very high equipment costs, which has been a barrier to its use outside research laboratories.

The fourth state of matter, plasma, is characterized by the fact that it consists of free charged particles, ions and electrons. In a DC plasma nitriding furnace an electrical voltage is applied between workload (the cathode) and the furnace vessel (the anode). A vacuum of the order of a few mbar is maintained in the vessel, which contains nitrogen gas. In the near vicinity of the load the electrical potential drops and a plasma with nitrogen ions is obtained. The positively charged nitrogen ions are accelerated by the electrical voltage towards the load. The nitrogen ion bombardment results in the nitriding of the steel as well as the heating of the part. Hydrogen is added to obtain reducing conditions and to control the nitriding potential. Argon is sometimes used as a cleaning agent before actual nitriding. The argon ions are heavy and therefore efficient in cleaning the surface by so-called sputtering, which is the removal of surface layer atoms by ion bombardment.

The DC plasma technology has tolerable weaknesses with respect to temperature uniformity and the risk of damage from arching. The availability of pulse plasma technology with multiple heating and cooling options minimize these drawbacks explicitly (see FIG. 14). An ongoing development that also eliminates these drawbacks is active screen plasma. In this case the plasma is created in a separate chamber, and a metal screen surrounding the load is used as the cathode. The plasma technique offers similar benefits to those of vacuum nitriding including very low consumption of gases. Austenitic nitrocarburizing is developed in order to create thicker cases that can sustain greater surface loads or bending stresses. It is performed at a temperature above the temperature for the partial transformation of the steel to austenite. At the process temperature austenite enriched with carbon and nitrogen is formed beneath the compound layer. Upon cooling after finalised nitrocarburizing some of this austenite will remain as retained austenite and some will transform into bainite, pearlite or martensite. A subzero treatment will transform the retained austenite further into martensite with a hardness in the range of 750 to 900 HV. Alternatively, a tempering operation can be carried out to transform the retained austenite into bainite/martensite. This will also raise the hardness both in the diffusion zone and in the compound layer.

A further improvement in corrosion resistance may be obtained if nitrocarburizing is followed by a short oxidation in the temperature range 450-550° C. (842-1022° F.). The aim is to create a Fe₃O₄ ferric oxide layer with a thickness of about 1 μm formed on top of the compound layer. Fe₂O₃ ferrous oxide should not be formed because it tends to deteriorate both the aesthetic surface appearance and corrosion resistance. If done properly, the oxidation treatment gives the processed parts an aesthetically attractive black color with high surface corrosion resistance.

In the gas post-oxidation process known in the art as the Nitrotec™ process, is based on the Nitemper process with an added oxidation step in air. Other oxidation methods using water vapor] or nitrous oxide (N₂O) produce treated layers of 5-50 micrometers thickness. The atmosphere for nitrocarburizing typically consists of 20-50% ammonia (or other nitrogen-available gases), 2-20% carbon dioxide and the balance nitrogen, the specific composition depending on which furnace equipment is used and which properties are desired. Experiments have shown that an addition of about 5 vol-percent CO₂.

In nitrocarburizing the compound layer starts to form by nucleation of cementite even if the carbon activity of the gas is lower than that of cementite. A possible explanation is that the gas/surface reaction delivering carbon to the surface (the heterogeneous water gas reaction) is faster and kinetically favored compared with the nitriding (ammonia decomposition) reaction during heating before reaching the nitrocarburizing temperature. There is additionally evidence that cementite formation at moderate atmosphere carbon activity is favored by the presence of ammonia in the atmosphere. Within the order of minutes after reaching the nitrocarburizing temperature, phase is nucleated on the primary formed cementite which is favored because its crystal structure is similar to that of cementite. The phase layer then grows at the expense of cementite, which is consumed by transformation to phase, leading to an almost homogeneous different phase layer. Later forms at Dependence of the thickness of the compound layer on the mean surface roughness Rz. 0.45% C carbon steel, nitriding temperature 570° C. (1058° F.), with the nitriding time at about 3 hours.

Effect of oxygen and water vapor on weight gain during nitriding in a thermo-balance at 550° C. (1022° F.) of Fe20Cr powder is discussed below. The ratio _{NH3}/_{H2} is used as a reference point at 32 the interface between the substrate and the ε′-layer. Redistribution of nitrogen and carbon at the 8/substrate interface will eventually create a second αphase layer between the ε′-layer and the substrate ε-phase. The compound layer will therefore ultimately consist of three alternating layers of α/ε/ε. This is indirectly corroborated by N and C concentration profiling. The nitrogen surface concentration increases with increased process time and increased nitriding potential, whereas the carbon surface concentration decreases. The total amount of nitrogen in the compound layer increases, whereas the total amount of carbon is constant or decreases with increased treatment time. Carbon is redistributed with a depletion of carbon in the intermediate ε′-layer, an accumulation of carbon in the α-phase adjacent to the core ferrite/cementite matrix and a positive carbon concentration gradient in the outer α-phase compound layer. For nitrocarburizing of medium and high carbon steels, carbon originating from the steel matrix is incorporated in the compound layer, resulting in carbon enrichment of the ε phase,

Additional coatings may be applied at the discretion of the manufacturer or end user. For example, silicon resin coatings, siliconizing of the surface and other polymers (e.g., highly-fluorinated resins) may also be applied to the nitrocarburized surface.

FIG. 3A is a cross-section of a metal-plated steel bolt 2. The bolt 2 has a central core 4 of steel and a surrounding plating layer 6. A nominal dimension along an end 8 of the bolt 2 is shown as X. The thickness of the plating is shown as p.

FIG. 3B is a cross-section of a stripped metal-plated steel bolt 10 with a central core 4 of steel and clean surfaces 12. The clean surfaces 12 will not likely display any residue of the stripped metal plating (not shown, as it has been removed). After removal of the metal-plating, the nominal dimension along end 8c is shown as X-p, where p was the thickness of the removed metal-plating layer.

FIG. 3C is a cross-section of a nitrocarburized, stripped, metal-plated steel bolt 14 in which a nitrocarburized zone 16 has been created to create a surface 18. The dimension along end 8 has been returned to a nominal dimension of X by expansion of the surface 18 by nominal dimension p by way of the creation of the nitrocarburizing zone 16. The thickness of the carburizing zone 18 is shown as p, the same dimension p, of the original plating layer 6 in FIG. 3A. End 8c is also shown.

The present technology may also be used to improve non-plated hydraulic connections, valves, couplers, nozzles, elbows, spray heads, venture tubes, splitters, elbows, male and female assemblies, hydraulic hoses, hydraulic gauges, hydraulic fittings, pneumatic fittings and instrumentation fittings. The provision of a nitrocarburized layer on an unfinished or polished steel core (formed by any one or combination of molding, forming, cutting, grinding and the other mechanical treatments) has been found to expand the field of use and endurance of the hydraulic connections or fittings, especially to strong chemical environments, metal on metal contacts and other corrosive or chemically or electronically oxidative or reducing environments.

Hydraulic fittings are parts used to connect hoses, pipes, and tubes in hydraulic systems. Hydraulic equipment generally operates under high pressures and is often not a fixed system. Consequently, hydraulic fittings need to be strong, versatile, and reliable to operate safely and effectively in their respective applications. These fittings typically adhere to strict standards which dictate fitting construction, dimensions, and pressure ratings.

### Hydraulic Pipes, Tubes, and Hoses

It is important to distinguish what type of hydraulic equipment is being connected in the system to determine what fittings are appropriate.

Hydraulic tubes are seamless precision pipes specially manufactured for hydraulics. The tubes have standard sizes for different pressure ranges, with standard diameters up to 100 mm. Tubes lengths are interconnected via flanges, welding nipples, flare connections, or by cut-rings. Direct joining of tubes by welding is not acceptable since the interior cannot be inspected.
Hydraulic pipes are larger diameter hydraulic tubes. Generally these are used for low pressure applications or when hydraulic tubes are not available. They can be connected by welds or threaded connections. Because of the larger diameters the pipe can usually be inspected internally after welding.
Hydraulic hose is graded by pressure, temperature, and fluid compatibility. Hoses are used in applications where pipes or tubes are not suitable, usually to provide flexibility for machine operation or maintenance. The hose consists of multiple layers of rubber and steel wire. Hydraulic hoses generally have steel fittings swaged on the ends. The weakest part of hydraulic hose is the connection of the hose to the fitting, which is why proper fitting selection and installation is essential in high pressure applications.

### Types of Fittings

Hydraulic fittings are distinguished based on the connection type and function it performs.
Hydraulic fittings are attached via a number of different connection methods, each with its own conveniences and advantages.
Compression fittings include all types of fittings which use compressive force to connect the vessel to the fitting.

Standard compression fittings use metal gaskets, rings, or ferrules which form a seal on the vessel through compression. The compression is typically made by tightening a nut onto the fitting over the piping and ferrule, compressing, and securing the vessel inside. Standard compression fittings do not require tools to assemble, making them convenient for quick field installations.

Bite-type fittings are compressive fittings with a sharpened ferrule that “bites” the vessel when compressed and provides the seal. Bite-type fittings, like standard compressive fittings, require no special tools to assemble, but provide a stronger, higher pressure connection.

Mechanical grip fittings are two-ferrule assemblies. The back ferrule grips the vessel while pressing up against the front ferrule, which spring-loads the front ferrule and creates a seal between the piping and fitting body. These fittings can be reassembled multiple times without damaging components or piping. They have good resistance to mechanical vibration.

Flare fittings consist of a body with a flared or coned end. Special flaring tools are used to install the vessel inside the flared end, providing a deep seal. Flare fittings can handle higher pressures and a wider range of operating parameters than standard compression fittings.

Crimp fittings involve placing hose over a tubular end and crimping against it with a sleeve, ring, or crimp socket. These fittings typically require crimping tools or machines to make the connections.

End fittings provide specific surfaces for connecting vessels in hydraulic systems.

Clamp ends are fittings which allow hoses or tubes to be clamped over the part.

Plain ends are fittings with surfaces which allow pipes or tubes to be connected by adhesive, solder, welding, or other permanent means. Welding, when done properly on compatible materials, provides a strong and reliable connection.

### Flange Fittings

Flange fittings are rims, edges, ribs, or collars with flush surfaces perpendicular to the attached pipe or tube. These surfaces are joined and sealed via clamps, bolts, welding, brazing, and/or threading. For more information on flanges, visit the Pipe Flanges Selection Guide on GlobalSpec.

Push-to-connect fittings have ends that are designed to accept tubing by pushing it into the end. These fittings typically disconnect via some type of collar retraction. These connections are convenient for sections of the system requiring frequent disconnection and reconnection.

Threaded fittings have screw threads (built-in grooves) on their inner (female) or outer (male) surfaces designed to accept connections with matching threads. Threads which provide a simple connection but no seal are called tapered threads. Tapered threads are designed to provide a tight seal for gases or fluids under pressure. Seal reliability can be improved by adding a coating or seal tape (Teflon). Especially precise threads are called “dry fit”, meaning they seal without the need for an additional sealant, which is important in applications where sealant addition could cause contamination or corrosion.

In order to differentiate between the various thread types, all that is needed is this reference chart, a caliper and a thread gage. The most important tool is the thread gage (or pitch gage). This tool, which has a saw tooth appearance, helps determine the thread pitch. It has a specified number of serrations within a certain distance and is (usually) marked accordingly. For metric threads, the pitch is considered as the distance, in millimeters, between each thread. For all other threads, the pitch is considered as the number of threads per inch.

| Step 1 | | | | |
|---|---|---|---|---|
| Determine | | | | Step 4 |
| if | Step 2 | Step 3 | | Define the |
| tapered or | Determine | Determine | Thread | Thread |
| parallel | pitch | size | type | (Examples) |
| Parallel | 12, 14, 16, 18, | Measure | UN/UNF | Size-pitch, |
| | 20, 24 | with | (SAE) | type |
| | | caliper | | ¾-16 |
| | | | | UN/UNF |
| Tapered | 11½, 14, 18, 27 | Compare | NPT/NPTF | Size-pitch, |
| | | with | (American | type |
| | | profile | Pipe) | ¼-18 NPT |
| Parallel | 11, 14, 19, 28 | Compare | BSPP | G, size* |
| | | with | (British | G⅛ |
| | | profile | Pipe) | |
| Tapered | 11, 14, 19, 28 | Compare | BSPT | R, size* |
| | | with | (British | R½ |
| | | profile | Pipe) | |
| Parallel | 1.0, 1.5, 2.0 | Measure | Metric | M, size × pitch |
| | | with | Parallel | M14 × 1.5 |
| | | caliper | | |
| Tapered | 1.0, 1.5, 2.0 | Measure | Metric | M, size × pitch, |
| | | with | Tapered | keg or Taper |
| | | caliper | | M10 × 1 keg or |
| | | | | Taper |

*For JIS (Japanese Industrial Standards), the thread can be identified similar to BSPP and BSPT but defined with PF and PT, respectively; for example, PF ⅛ and PT ½.

JIC fittings, defined by the SAE J514 and MIL-F-18866 standards, are a type of flare fitting machined with a 37-degree flare seating surface. JIC (Joint Industry Council) fittings are widely used in fuel delivery and fluid power applications, especially where extremely high pressure is involved. The SAE J514 standard replaces the MS 16142 military specification, although some tooling is still listed under MS 16142. JIC fittings are dimensionally identical to AN (Aeronautical-Navy) fittings, but are produced to less exacting tolerances and are generally less costly. SAE 45-degree flare fittings are similar in appearance, but are not interchangeable though dash sizes 2, 3, 4, 5, 8, 10, 14, and 16 share the same thread size. Some couplings may have dual machined seats for both 37-degree and 45-degree flare seats. Komatsu and JIS (Japanese Industrial Standard) fittings have flare ends similar to JIC fittings. Komatsu and JIS both use a 30-degree flare seating surface. The only difference is Komatsu uses millimeter thread sizes while JIS use a BSP (British Standard Pipe) thread. JIC fitting systems have three components that make a tubing assembly: fitting, flare nut, and sleeve. As with other flared connection systems, the seal is achieved through metal-to-metal contact between the finished surface of the fitting nose and the inside diameter of the flared tubing. The sleeve is used to evenly distribute the compressive forces of the flare nut to the flared end of the tube. Materials commonly used to fabricate JIC fittings include forged-carbon steel, forged stainless steel, forged brass, machined brass, Monel and nickel-copper alloys.

JIC fitting are commonly used in the Fluid Power industry in a diagnostic and test-point setting. A three way JIC coupling provides a port inline of circuit in which a user can connect a measurement or diagnostic device to take pressure readings and perform circuit and system diagnostics.

Although specific dimensions, proportions, temperatures and concentrations have been presented, variations and alternatives may be used within the scope of the invention represented in the claims.

What is claimed:

1. A process for enhancing at least surface hardness of a metal-plated iron-containing component comprising:
a) providing a plated iron-containing component;
b) stripping metal plating from at least some surfaces of the plated iron-containing component, exposing iron-containing material within a body of the component;
c) nitrocarburizing exposed iron-containing material of the body to at least enhance surface hardness of the exposed iron-containing material of the body.

2. The process of claim 1 wherein the iron-containing component is a steel component.

3. The process of claim 1 wherein the metal plating is a plating of metal selected from the group consisting of chromium, zinc, tin, rhodium, platinum, metal alloys, silver and gold.

4. The process of claim 1 wherein the metal plating is a plating of metal selected from the group consisting of chromium, zinc, tin, rhodium, platinum, and metal alloys.

5. The process of claim 2 wherein the metal plating is a plating of metal selected from the group consisting of chromium, zinc, tin, rhodium, platinum, metal alloys, silver and gold.

6. The process of claim 1 wherein the metal plating is stripped from the at least some surfaces by an acid treatment process.

7. The process of claim 1 wherein the metal plating is stripped from substantially all exposed surfaces of the metal plated iron-containing component by an acid treatment process.

8. The process of claim 2 wherein the metal plating is stripped from substantially all exposed surfaces of the metal plated steel-containing component by an acid treatment process.

9. The process of claim 5 wherein the metal plating is stripped from substantially all exposed surfaces of the metal plated steel-containing component by an acid treatment process.

10. The process of claim 2 wherein mild oxidation is performed on the nitrocarburized surface.

11. The process of claim 5 wherein mild oxidation is performed on the nitrocarburized surface.

12. The process of claim 8 wherein mild oxidation is performed on the nitrocarburized surface.

13. The process of claim 9 wherein mild oxidation is performed on the nitrocarburized surface.

14. The process of claim 2 wherein metal-plated steel component has a nominal dimension of 100 units and a tolerance of ±y units and the component after the nitrocarburization has a nominal dimension at a same dimensional measuring point of 100 units plus 1.05 times±y.

15. The process of claim 2 wherein metal-plated steel component has a nominal dimension of 100 units and a tolerance of ±y units and the component after the nitrocarburization has a nominal dimension at a same dimensional measuring point of 100 units plus 1.01 times±y.

16. The process of claim 5 wherein metal-plated steel component has a nominal dimension of 100 units and a tolerance of ±y units and the component after the nitrocarburization has a nominal dimension at a same dimensional measuring point of 100 units plus 1.00 times±y.

17. An enhanced steel component product produced by the method of claim 1.

18. An enhanced steel component product produced by the method of claim 2.

19. An enhanced steel component product produced by the method of claim 5.

20. An enhanced steel component product produced by the method of claim 8.

21. A hydraulic fitting having an improved surface resistance to corrosion comprising:
a metal-plated iron-containing core:
surfaces free of plated metal;
a nitrocarburized zone over the entire surface of the fitting which enhances surface corrosion resistance against chemical oxidation and chemical reduction.

22. The fitting of claim 21 wherein the fitting is selected from the group consisting of hydraulic male and female connections, gages, spray heads, nozzles, and elbows.

23. The fitting of claim 22 wherein the core has a nitrocarburized zone with a thickness of 0.01 to 0.8 mm.
